(19) United States
(12) Patent Application Publication
(10) Pub. No.: US 2025/0153566 A1
(43) Pub. Date: May 15, 2025

(54) ACTUATOR

(71) Applicant: DENSO CORPORATION, Kariya-city (JP)

(72) Inventor: Noriyuki INAGAKI, Kariya-city (JP)

(21) Appl. No.: 19/028,281

(22) Filed: Jan. 17, 2025

Related U.S. Application Data
(63) Continuation of application No. PCT/JP2023/033057, filed on Sep. 11, 2023.

(30) Foreign Application Priority Data
Sep. 30, 2022 (JP) 2022-159083

(51) Int. Cl. B60K 26/02; G05G 1/38; G05G 1/44; G05G 5/03

(52) U.S. Cl. CPC B60K 26/021; G05G 1/38; G05G 1/44; G05G 5/03; B60K 2026/023; B60Y 2400/3012; B60Y 2400/4026; B60Y 2400/405; B60Y 2400/41; B60Y 2400/70; B60Y 2410/102

(57) ABSTRACT

An actuator applies a reaction force to a pedal lever to be depressed by a human driver. The actuator includes an electric motor, a speed reducer mechanism, an actuator lever and an angle detector device. The speed reducer mechanism includes: a motor gear that rotates integrally with the electric motor; an output gear that rotate integrally with an output shaft; and an intermediate gear installed between the motor gear and the output gear. The actuator lever is driven by the output shaft and contacts the pedal lever. The angle detector device detects a rotational angle of the intermediate gear. The intermediate gear has: a large gear portion, which meshes with the motor gear; and a small gear portion, which meshes with the output gear. The small gear portion is integrally formed in one-piece with the large gear portion.

### CROSS REFERENCE TO RELATED APPLICATIONS

This application is a continuation application of International Patent Application No. PCT/JP2023/033057 filed on Sep. 11, 2023, which designated the U.S. and claims the benefit of priority from Japanese Patent Application No. 2022-159083 filed on Sep. 30, 2022. The entire disclosures of all of the above applications are incorporated herein by reference.

### TECHNICAL FIELD

The present disclosure relates to an actuator.

### BACKGROUND

Previously, there has been proposed an actuator that applies a reaction force to an accelerator pedal. In this actuator, the reaction force is applied to the accelerator pedal to counteract a pedal force applied to the accelerator pedal based on a monitoring result of a pedal monitoring device that monitors the operational state of the accelerator pedal.

### SUMMARY

This section provides a general summary of the disclosure, and is not a comprehensive disclosure of its full scope or all of its features.

According to the present disclosure, there is provided an actuator configured to apply a reaction force to a pedal lever that is configured to be depressed by a human driver of a vehicle. The actuator includes an electric motor, a speed reducer mechanism and an angle detector device. The speed reducer mechanism includes: a motor gear that is configured to rotate integrally with the electric motor; an output gear that is configured to rotate integrally with an output shaft; and an intermediate gear that is installed between the motor gear and the output gear. The angle detector device is configured to detect a rotational angle of the intermediate gear. The intermediate gear has a large gear portion, which meshes with the motor gear; and a small gear portion, which meshes with the output gear. The small gear portion is integrally formed in one-piece with the large gear portion.

### BRIEF DESCRIPTION OF DRAWINGS

The drawings described herein are for illustrative purposes only of selected embodiments and not all possible implementations, and are not intended to limit the scope of the present disclosure.

FIG. 1 is a schematic diagram showing an accelerator device according to a first embodiment.

FIG. 2 is a plan view showing an actuator according to the first embodiment.

FIG. 3 is a cross-sectional view taken along line III-III in FIG. 2.

FIG. 4 is a plan view showing the actuator from which a cover is removed according to the first embodiment.

FIG. 5 is a cross-sectional view taken along line V-V in FIG. 4.

FIG. 6 is a schematic diagram showing the accelerator device mounted on a vehicle according to the first embodiment.

FIG. 7 is a schematic diagram for describing moments applied to a bearing of an output shaft according to the first embodiment.

FIG. 8 is a schematic diagram for describing moments applied to a bearing of an intermediate shaft according to the first embodiment.

FIG. 9 is a schematic diagram for describing an external force applied to the intermediate shaft according to the first embodiment.

FIG. 10 is a cross-sectional view showing an actuator according to a second embodiment.

FIG. 11 is a schematic diagram illustrating an external force applied to the intermediate shaft according to the second embodiment.

FIG. 12 is a cross-sectional view showing an actuator according to a third embodiment.

FIG. 13 is a cross-sectional view showing an actuator according to a fourth embodiment.

FIG. 14A is a schematic diagram showing a bearing of an intermediate shaft according to a comparative example.

FIG. 14B is a schematic diagram illustrating an external force applied to the intermediate shaft according to the comparative example.

### DETAILED DESCRIPTION

Previously, there has been proposed an actuator that applies a reaction force to an accelerator pedal. In this actuator, the reaction force is applied to the accelerator pedal to counteract a pedal force applied to the accelerator pedal based on a monitoring result of a pedal monitoring device that monitors the operational state of the accelerator pedal.

In a case where the reaction force is applied to the accelerator pedal by a rotatable lever from the actuator, even if the same torque is outputted, an output load from the lever varies with an opening degree of the accelerator pedal due to changes in a contact angle of the lever.

According to the present disclosure, there is provided an actuator configured to apply a reaction force to a pedal lever that is configured to be depressed by a human driver of a vehicle. The actuator includes an electric motor, a speed reducer mechanism, an actuator lever and an angle detector device. The speed reducer mechanism includes: a motor gear that is configured to rotate integrally with the electric motor; an output gear that is configured to rotate integrally with an output shaft; and an intermediate gear that is installed between the motor gear and the output gear. The actuator lever is configured to be driven by the output shaft and is configured to contact the pedal lever. The angle detector device is configured to detect a rotational angle of the intermediate gear.

The intermediate gear has: a large gear portion, which meshes with the motor gear; and a small gear portion, which meshes with the output gear. The small gear portion is integrally formed in one-piece with the large gear portion. By using a detected value of the angle detector device in operation control calculations, the operation of the actuator can be appropriately controlled.

Hereinafter, embodiments of the present disclosure will be described with reference to the drawings. In the following description, the same reference signs are given to substantially the same portions among the embodiments, and the redundant description thereof will be omitted for the sake of simplicity.

### First Embodiment

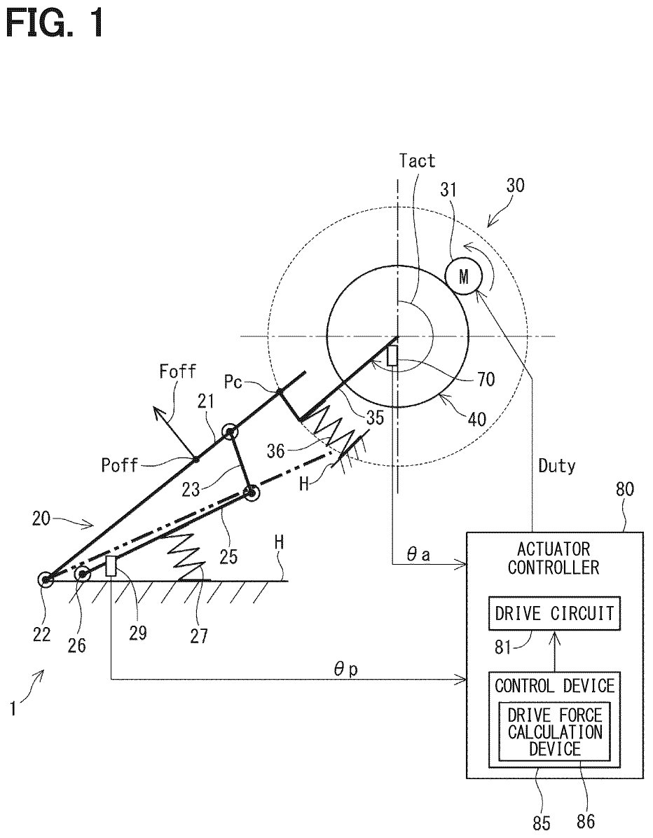

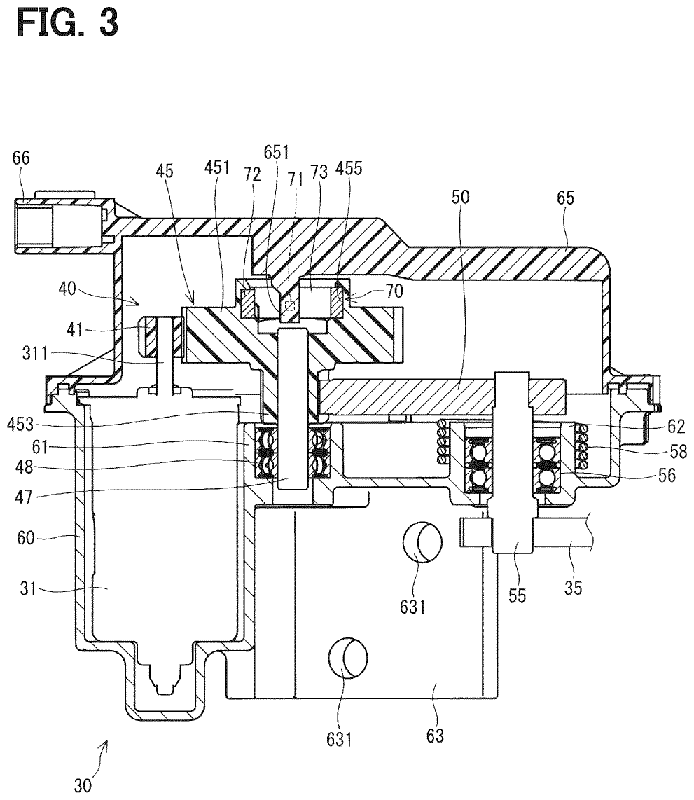

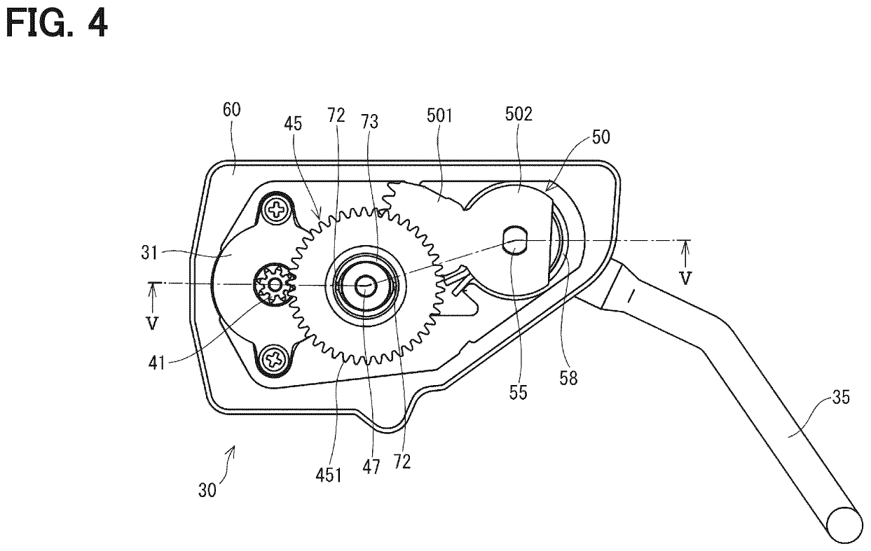

FIGS. 1 to 9 show an actuator according to the first embodiment. As shown in FIG. 1, the actuator 30 is applied to an accelerator device 1. The accelerator device 1 includes a pedal lever 20, the actuator 30 and an actuator controller 80.

The pedal lever 20 includes a pad 21, an arm 23 and a pedal 25 and is driven integrally by a depressing operation of a human driver (hereinafter, simply referred to as “driver”) of a vehicle for depressing the pedal lever 20. The pad 21 is configured to be operated by the depressing operation of the driver. The pad 21 is rotatably supported by a fulcrum member 22 installed to a housing H. FIG. 1 shows a floor-mounted type (organ-type) in which the pad 21 extends in a direction along a surface of the housing H, but it may be a suspended type (pendant type). In FIG. 1, housings, such as a pedal housing, a motor housing, which are not moved by the operation of the electric motor 31 or the depressing operation of the pedal lever 20, will be collectively referred to as the housing H.

The arm 23 couples between the pad 21 and the pedal 25. One end portion of the pedal 25 is rotatably supported by the housing H through a fulcrum member 26, and the other end portion of the pedal 25 is coupled to the arm 23. As a result, the pad 21, the arm 23 and the pedal 25 are driven integrally through the operation of the pad 21 by the driver. A pedal opening degree sensor 29, which detects a pedal opening degree θp, is installed to the one end portion of the pedal 25.

A pedal urging member 27 is a compression coil spring having one end portion fixed to the pedal 25 and the other end portion fixed to the housing H. The pedal urging member 27 urges the pedal 25 in an accelerator closing direction. In FIG. 1, a position of the pad 21 at the time of accelerator full opening and a position of the pad 21 at the time of accelerator full closing are indicated by a dot-dot-dash line and a solid line, respectively.

As shown in FIGS. 1 to 5, the actuator 30 includes an electric motor (serving as a drive power source) 31, an actuator lever 35, a speed reducer mechanism 40, a housing 60 and a cover 65. The electric motor 31 is, for example, a brushed DC motor. A drive force of the electric motor 31 is transmitted to the pedal lever 20 through the speed reducer mechanism 40 and the actuator lever 35. Details of the speed reducer mechanism 40 will be described later.

The actuator lever 35 contacts the pedal lever 20 through a distal end portion 351 of the actuator lever 35. Although the actuator lever 35 contacts the pad 21 in FIG. 1, the actuator lever 35 may be configured to contact the arm 23 or the pedal 25. The distal end portion 351 is shaped in a spherical form.

As shown in FIG. 1, the actuator lever 35 is urged in a reaction force application direction by an actuator lever urging member 36. The actuator lever urging member 36 is, for example, a compression coil spring. A spring force of this compression coil spring is set such that the actuator lever 35 is always in contact with the pedal lever 20.

The actuator controller 80 includes a drive circuit 81 and a control device 85. The drive circuit 81 is formed, for example, by an H-bridge circuit and includes switching devices (not shown) for switching the electric power supply to the electric motor 31.

The control device 85 includes a microcomputer as its main component and has a CPU, a ROM, a RAM, an I/O device and bus lines connecting these components, all of which are not shown in the drawing. The processes executed by the control device 85 may be software processes executed by the CPU based on programs stored in a tangible memory device such as the ROM (i.e., readable non-transitory tangible recording medium), or they may be hardware processes performed by dedicated electronic circuits.

The control device 85 includes a drive force calculation device 86 as a functional block. The drive force calculation device 86 calculates a target torque T* such that a reaction force corresponding to a target reaction force F* obtained from a host ECU (not shown) is outputted. The control device 85 controls the operation of the drive circuit 81 with a duty ratio corresponding to the target torque T* to control the operation of the electric motor 31.

The drive force calculation device 86 calculates the target torque T* by using an actuator angle θa obtained based on a detected value of an actuator sensor 70. Instead of the actuator angle θa, a pedal opening degree θp obtained based on a detected value of the pedal opening degree sensor 29 may be used. The pedal opening degree θp may be directly obtained from the pedal opening degree sensor 29 or may be obtained from the host ECU via communication.

The control device 85 learns the detected value of the actuator sensor 70 at the fully closed state of the pedal lever 20 as a reference position, and the control device 85 converts the actuator angle θa to the pedal opening degree θp by converting this reference position using a gear ratio and a lever length ratio. In the present embodiment, when a start switch, such as an ignition switch, is turned on, it is assumed that the pedal lever 20 is placed in the fully closed state, and the detected value of the actuator sensor 70 at this time is learned as the reference position. Additionally, for example, calibration may be performed by comparing the detected value of the pedal opening degree sensor 29 with the detected value of the actuator sensor 70 during the running time of the vehicle.

When the pedal lever 20 is depressed, a position and a contact angle of a pedal contact point Pc, which is a contact point between the pedal lever 20 and the actuator lever 35, shift. Here, it is assumed that a representative point where a foot of the driver contacts the pedal lever 20 is a reaction force off point Poff. Under this assumption, when a constant motor torque Tact is outputted, a reaction force Foff, which is applied to the reaction force off point Poff, changes according to the pedal opening degree θp.

Therefore, in the present embodiment, the motor torque is corrected using the actuator angle θa such that the reaction force Foff, which is applied to the reaction force off point Poff, becomes the target reaction force F*, regardless of the pedal opening degree θp. This allows the applied reaction force to be appropriately controlled.

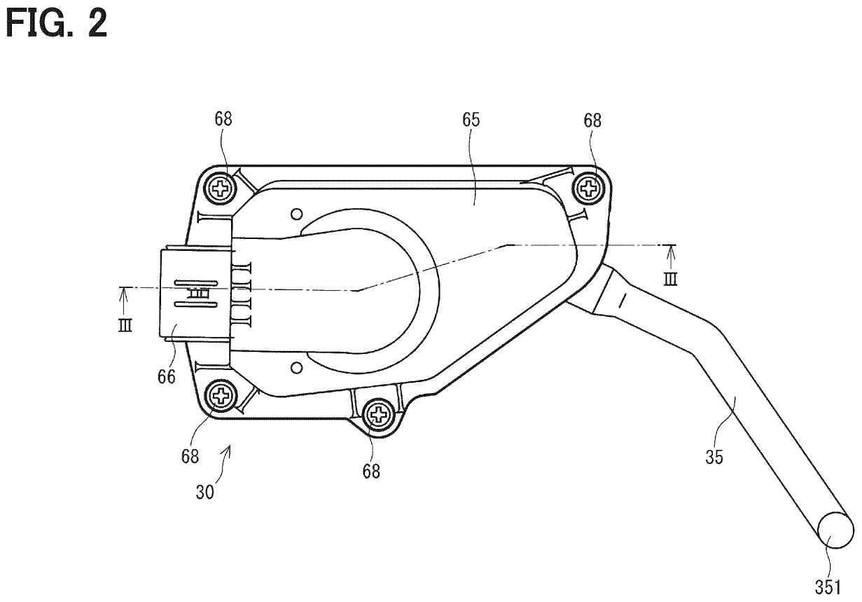

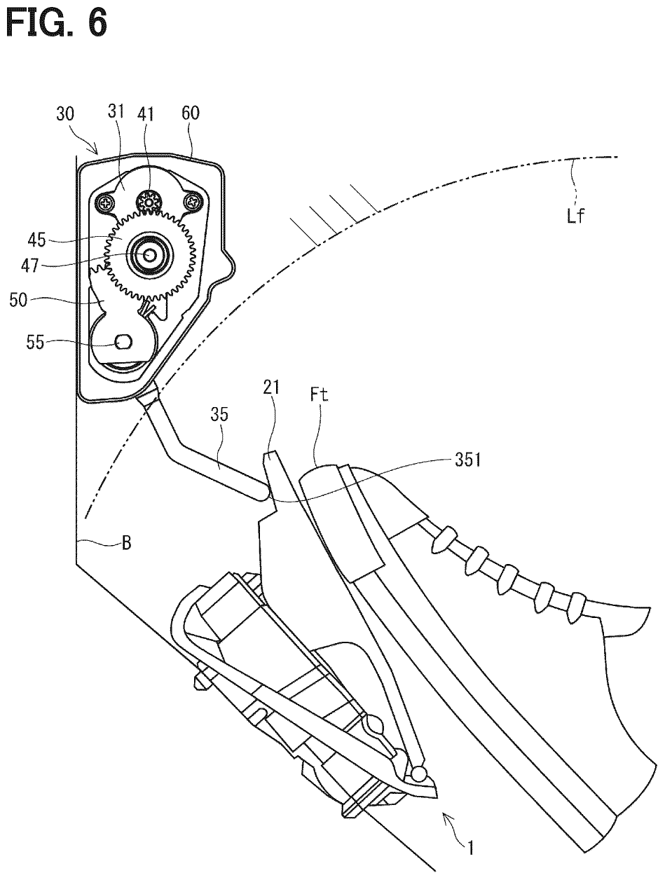

As shown in FIGS. 2 to 5, the housing 60 receives the electric motor 31, and a flange 63 is provided to the housing 60. A plurality of holes 631 are formed at the flange 63, and the flange 63 is attached to a vehicle body B (see FIG. 6) by bolts or the like (not shown) inserted through the holes 631. A connector 66 is provided on the cover 65, and the cover 65 is fixed to the housing 60 with a plurality of bolts 68.

The speed reducer mechanism 40 includes a motor gear 41, an intermediate gear 45 and an output gear 50 and is received in a space formed by the housing 60 and the cover 65. There is play between the corresponding components of the speed reducer mechanism 40. Hereinafter, the play between the components will be referred to as backlash. The motor gear 41 is configured to rotate integrally with a motor shaft 311.

The intermediate gear 45 has a large gear portion 451 and a small gear portion 453, and the intermediate gear 45 is integrally formed in one-piece, for example, from resin or the like. The large gear portion 451 is formed to have a larger diameter than the motor gear 41 and the small gear portion 453 and meshes with the motor gear 41. The small gear portion 453 is positioned on a side of the large gear portion 451 opposite to the cover 65 and meshes with the output gear 50.

One end portion of the intermediate shaft 47 is insert-molded into the intermediate gear 45, and the other end portion of the intermediate shaft 47 projects from the small gear portion 453. The intermediate shaft 47 is rotatably supported by the housing 60 through a bearing member 48 on the side opposite to the cover 65. As a result, the intermediate gear 45 is rotatably supported by the housing 60. In the present embodiment, the bearing member 48 is two ball bearings 481, 482 and is received in a bearing receiving portion 61 formed at the housing 60. The number of the ball bearings may be three or more.

The output gear 50 has: a gear portion 501 that meshes with the small gear portion 453 of the intermediate gear 45; and a shaft portion 502. The output gear 50 is integrally formed in one-piece, for example, from metal or the like. One end portion of an output shaft 55, which has two diametrically opposed flat outer surfaces, is press-fitted into a hole of the shaft portion 502, which has two diametrically opposed flat inner surfaces. The other end portion of the output shaft 55, which has two diametrically opposed flat outer surfaces, projects from the housing 60 and is press-fitted into a hole of the actuator lever 35, which has two diametrically opposed flat inner surfaces.

The output shaft 55 is rotatably supported by the housing 60 through a bearing member 56. In the present embodiment, the bearing member 56 is two ball bearings and is received in a bearing receiving portion 62 formed at the housing 60.

A torsion spring 58 is installed on a radially outer side of the bearing receiving portion 62. One end portion of the torsion spring 58 is fixed to the housing 60, and the other end portion of the torsion spring 58 is fixed to the output gear 50. With this configuration, by urging the output gear 50, the backlash between the intermediate gear 45 and the output gear 50 can be eliminated at the time of outputting the load. Thus, it is possible to calculate the rotational angle of the output shaft 55 based on the rotational angle of the intermediate gear 45.

The actuator sensor 70 includes a sensor device 71, magnets 72 and a magnetic yoke 73. The sensor device 71, such as a Hall IC, is held by a projection 651, which projects from the cover 65, such that the sensor device 71 is positioned on a radially inner side of the magnetic yoke 73 so as to sense a magnetic flux of a magnetic circuit formed by the magnets 72 and the magnetic yoke 73. With this configuration, the sensor device 71 can sense the rotation of the intermediate gear 45.

The magnets 72 and the magnetic yoke 73 are fixed to a magnetic circuit receiving portion 455 formed at the intermediate gear 45 and are thereby rotated integrally with the intermediate gear 45. The magnetic yoke 73 is shaped generally in a circular ring form and clamps the magnets 72 such that the magnets 72 are arranged at a predetermined interval (e.g., 180 degrees).

In the present embodiment, the actuator sensor 70 is configured to sense the rotation of the intermediate gear 45. As a result, compared to a configuration where the rotation of the output gear 50 is sensed, it is possible to reduce the size around the output shaft 55. As shown in FIG. 6, by reducing the size around the output shaft 55, it is possible to avoid interference with a moving range of a toe Ft of the driver indicated by a dot-dot-dash line Lf, thereby improving mountability. FIG. 6 shows a state where the cover 65 is removed from the actuator 30.

An operating angle of the output shaft 55 is relatively small, approximately 30 to 50 degrees. On the other hand, the intermediate shaft 47 has a larger operating angle compared to the output shaft 55, making it possible to sense the rotational position with relatively high accuracy. A gear ratio is set such that the rotational angle of the intermediate shaft 47 is less than 360 degrees.

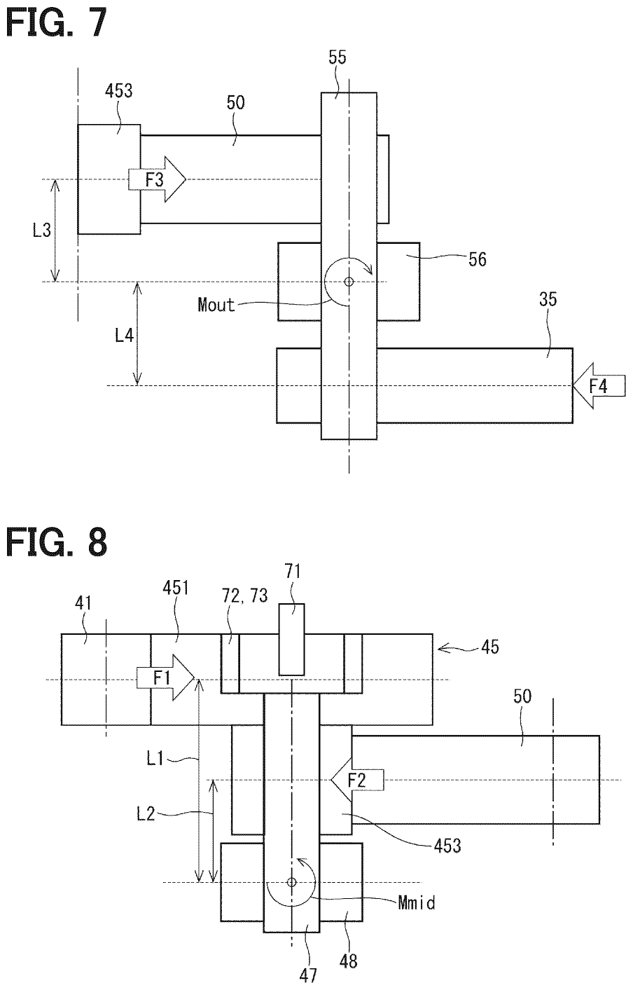

As shown in FIG. 7, the output shaft 55 is rotatably supported between the output gear 50 and the actuator lever 35. Therefore, a moment Mout, which results from a gear external force applied to the output shaft 55, is given by Equation (1) shown below. Here, a moment resulting from a force F3 applied by the small gear portion 453 of the intermediate gear 45 and a moment resulting from a force F4 applied by the actuator lever 35 act in the same direction (clockwise on the drawing) relative to the bearing. Thus, the moment Mout is increased, and the amount of deformation at an end portion of the output shaft 55 is increased. In FIG. 7, the depiction of the structure on the motor gear 41 side of the central axis of the small gear portion 453 is omitted for simplicity.

In the present embodiment, the actuator sensor 70 is installed to the intermediate gear 45, and the intermediate shaft 47 is supported at an end portion of the intermediate shaft 47 which is opposite to the actuator sensor 70, and thereby the actuator sensor 70, the large gear portion 451, the small gear portion 453 and the bearing member 48 are arranged in this order from the cover 65 side.

As shown in FIG. 8, a moment Mmid, which results from a gear external force applied to the intermediate shaft 47, is given by the Equation (2) shown below. Here, a moment resulting from a force F1 applied by the motor gear 41 and a moment resulting from a force F2 applied by the output gear 50 act in opposite directions with respect to the bearing. Thus, the moment Mmid is reduced, and the amount of deformation at an end portion of the intermediate shaft 47 is reduced. That is, if the bearing rigidity is the same, the intermediate shaft 47 is subjected to less external force in the shaft tilting direction compared to the output shaft 55, making it advantageous in terms of detection accuracy.

$$Mout = F 3 \times L 3 + F 4 \times L 4 \qquad Equation ( 1 )$$

$$Mmid = - F 1 \times L 1 + F 2 \times L 2 \qquad Equation ( 2 )$$

In the equations shown above, L1 is a distance between: a meshing position between the motor gear 41 and the large gear portion 451; and the bearing member 48, L2 is a distance between a meshing position between the small gear portion 453 and the output gear 50; and the bearing member 48. Furthermore, L3 is a distance between: a meshing position between the small gear portion 453 and the output gear 50; and the bearing member 56, and L4 is a distance between: a fitting position between the actuator lever 35 and the output shaft 55; and the bearing member 56.

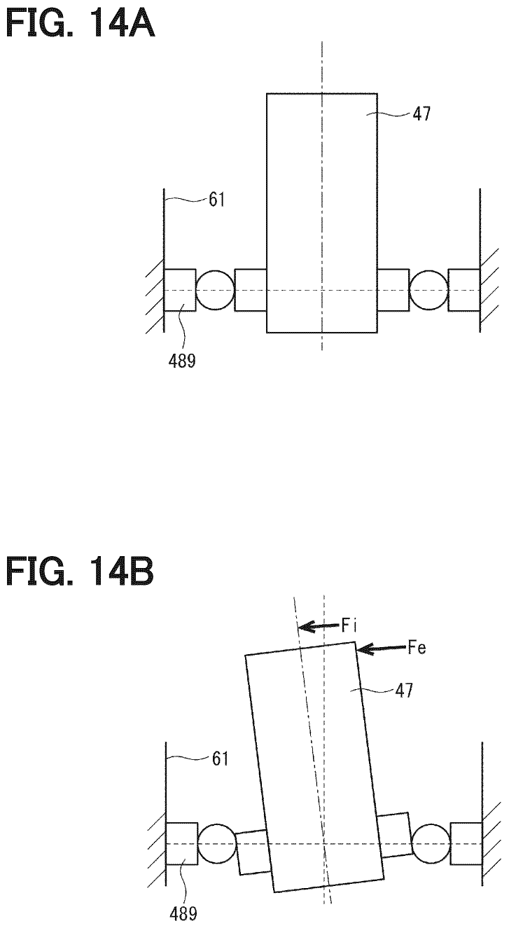

As described above, in the present embodiment, the intermediate shaft 47 is rotatably supported by the housing 60 in a so-called “cantilevered” state through the bearing member 48. Here, as shown in FIG. 14A, in a comparative example where the intermediate shaft 47 is supported by a single ball bearing 489, when a gear external force is applied to the intermediate shaft 47 as indicated by an arrow Fe in FIG. 14B, the intermediate shaft 47 tilts (see an arrow Fi) even in a state where the internal clearance is negative. In the case where the actuator sensor 70 is installed to the intermediate gear 45, when the intermediate shaft 47 tilts, the detection accuracy deteriorates.

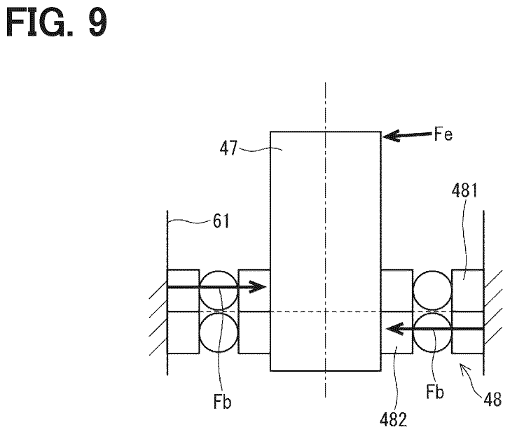

In view of the above-described point, according to the present embodiment, the bearing member 48 is formed by the two ball bearings 481, 482. These ball bearings 481, 482 are placed in a state where an internal clearance of each ball bearing 481, 482 is set to zero or less by press-fitting the intermediate shaft 47, which holds an inner race of each ball bearing 481, 482, relative to an outer race of the ball bearing 481, 482 held by the housing 60, while pressing balls by the inner race against the outer race. Thus, as indicated by arrows Fb in FIG. 9, the tilting of the intermediate shaft 47 induced by the gear external force can be limited. Additionally, compared to the output shaft 55, the intermediate shaft 47 is subjected to less external force since it is positioned before the speed reduction of the rotation takes place.

By supporting the intermediate shaft 47 with the two ball bearings 481, 482, the amount of shaft play is reduced, allowing for the suppression of meshing rate and backlash fluctuations. This allows for the suppression of torque fluctuations and operational noise caused by pedal force fluctuations during the pedal operation.

As described above, the actuator 30 of the present embodiment is configured to apply the reaction force to the pedal lever 20 that is configured to be depressed by the driver of the vehicle. The actuator 30 includes the electric motor 31, the speed reducer mechanism 40, the actuator lever 35 and the actuator sensor 70. The speed reducer mechanism 40 includes: the motor gear 41 that is configured to rotate integrally with the electric motor 31; the output gear 50 that is configured to rotate integrally with the output shaft 55; and the intermediate gear 45 that is installed between the motor gear 41 and the output gear 50.

The actuator lever 35 is configured to be driven by the output shaft 55 and is configured to contact the pedal lever 20. The actuator sensor 70, which serves as an angle detector device, is configured to detect the actuator angle θa which is the rotational angle of the intermediate gear 45.

The intermediate gear 45 has: the large gear portion 451, which meshes with the motor gear 41; and the small gear portion 453, which meshes with the output gear 50 and is integrally formed in one-piece with the large gear portion 451. By using the actuator angle θa in operation control calculations, the operation of the actuator 30 can be appropriately controlled. Specifically, output control and fault diagnosis can be performed based on the actuator angle θa. By performing the output control based on the actuator angle θa, the applied reaction force can be accurately controlled. Additionally, by integrally forming the large gear portion 451 and the small gear portion 453 in one-piece, it is possible to transmit the load between these gear portions without generating play therebetween, thereby improving responsiveness.

The intermediate gear 45 is rotatably supported by the bearing member 48. This allows for the suppression of the wobbling of the intermediate gear 45 caused by the backlash of the speed reducer mechanism 40, thereby improving the detection accuracy of the actuator sensor 70.

The actuator sensor 70, the large gear portion 451, the small gear portion 453 and the bearing member 48 are arranged in this order from the one side in the axial direction of the intermediate gear 45. With this configuration, since the moment caused by the external force applied to the large gear portion 451 and the moment caused by the external force applied to the small gear portion 453 counteract each other, the fluctuations of the intermediate shaft 47 can be limited, thereby further improving the detection accuracy of the actuator sensor 70. Additionally, by holding the intermediate gear 45 in a so-called “cantilevered” state, it contributes to the size reduction of the actuator 30 compared to a case where bearings are provided in two or more locations.

The intermediate gear 45 is configured to rotate integrally with the intermediate shaft 47. The intermediate shaft 47 is rotatably supported by the housing 60 through the ball bearings 481, 482 which form the bearing member 48. In the present embodiment, the bearing member 48 supports the intermediate shaft 47 in the state where the internal clearance of the bearing member 48 is zero or less. Thus, the tilting of the intermediate shaft 47 and the fluctuations in the durability against the backlash of the speed reducer mechanism 40 can be limited, thereby further improving the detection accuracy of the actuator sensor 70. Furthermore, the torque fluctuations and the operational noise can be limited during the pedal operation.

### Second Embodiment

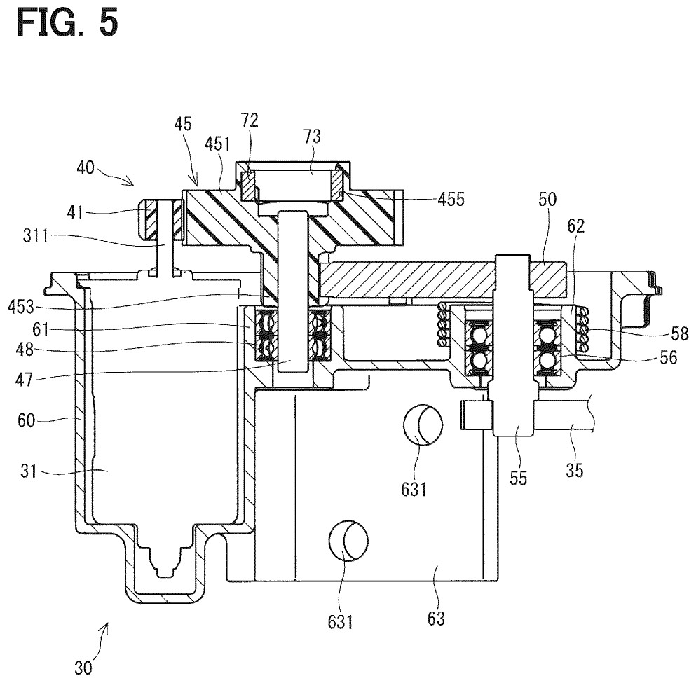

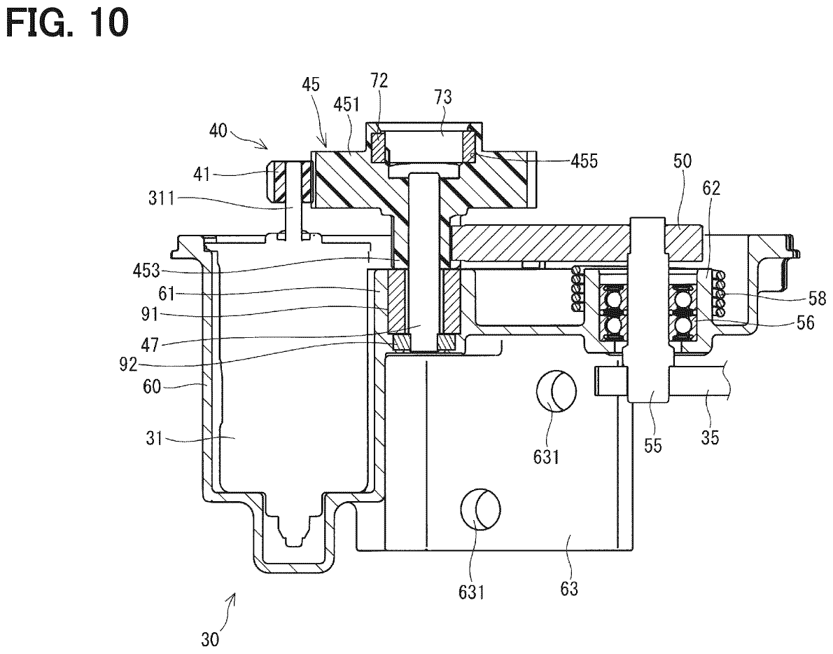

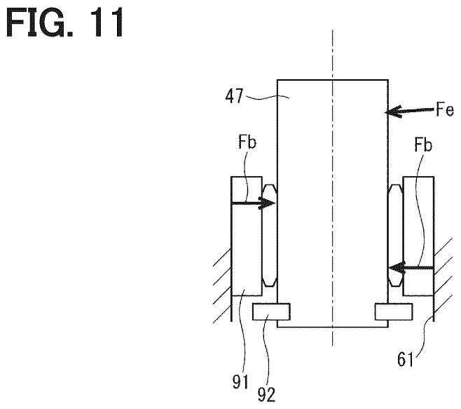

FIGS. 10 and 11 show the second embodiment. In the second to fourth embodiments, since the bearing structure of the intermediate shaft differs from the above-described embodiment, the second to fourth embodiments will be explained focusing on this point. FIGS. 10, 12 and 13 are cross-sectional views corresponding to FIG. 5 of the first embodiment.

As shown in FIG. 10, a bearing member 91 of the present embodiment is formed by a needle bearing. A C-ring 92, which receives a load in a thrust direction, is installed on a side of the bearing member 91 which is opposite to the intermediate gear 45.

As shown in FIG. 11, in the case where the bearing member 91 is formed by the needle bearing, by setting the internal clearance of the bearing member 91 to zero, it is possible to limit the tilting of the intermediate shaft 47 caused by the gear external force, similar to the case where the two ball bearings are used.

In the present embodiment, the intermediate shaft 47 is rotatably supported by the housing 60 through the needle bearing which forms the bearing member 91. Even when the bearing member 91 is formed by the needle bearing, it can be used in the state where the internal clearance is zero. Therefore, the tilting of the intermediate shaft 47 and the fluctuations in the durability against the backlash of the speed reducer mechanism 40 can be limited, similar to the case where the ball bearings are used. Thereby, the detection accuracy of the actuator sensor 70 can be further improved. Furthermore, the advantages similar to those described in the above embodiment can be achieved.

### Third Embodiment

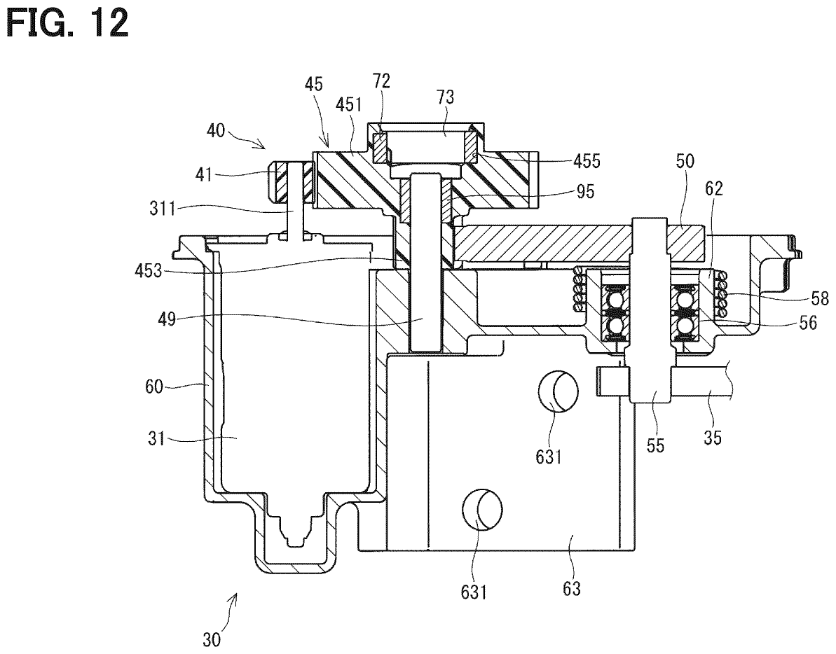

As shown in FIG. 12, in the third embodiment, one end portion of an intermediate shaft 49 is securely press-fitted to the housing 60, and the other end portion of the intermediate shaft 49 projects from the housing 60. The intermediate gear 45 is installed on the radially outer side of the other end portion of the intermediate shaft 49. A bearing member 95 is positioned between the intermediate gear 45 and the intermediate shaft 49 on the radially inner side of the intermediate gear 45 and rotatably supports the intermediate gear 45, enabling the rotation of the intermediate gear 45 relative to the intermediate shaft 49. The bearing member 95 may be the ball bearings or the needle bearing.

In the present embodiment, the bearing member 95 is positioned between: the intermediate shaft 49 fixed to the housing 60; and the intermediate gear 45, and the bearing member 95 rotatably supports the intermediate gear 45, enabling the rotation of the intermediate gear 45 relative to the intermediate shaft 49. Even with the configuration described above, the advantages similar to those described in the above embodiment(s) can be achieved.

### Fourth Embodiment

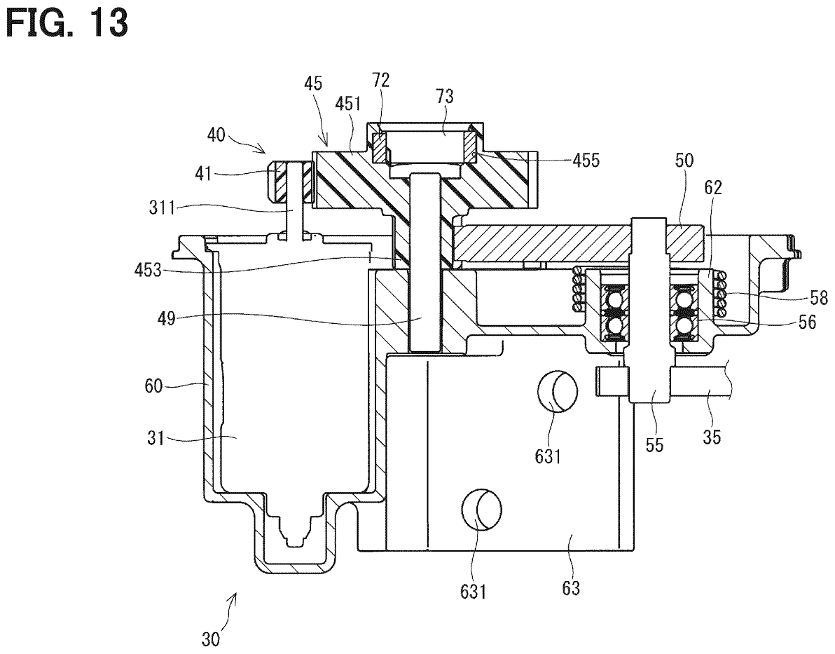

As shown in FIG. 13, in the fourth embodiment, the one end portion of the intermediate shaft 49 is securely press-fitted to the housing 60, and the other end portion of the intermediate shaft 49 projects from the housing 60, similar to the third embodiment. The intermediate gear 45 is rotatably held on the radially outer side of the other end portion of the intermediate shaft 49. In the present embodiment, the bearing member is not separately provided as the separate component. Even with the configuration described above, the advantages similar to those described in the above embodiment(s) can be achieved.

### Other Embodiments

In the embodiments described above, the actuator lever is always in contact with the pedal lever by means of the resilient member. In another embodiment, the actuator lever and the pedal lever may be driven integrally using means other than the resilient member, or the resilient member may be omitted.

In another embodiment, a locking mechanism using a plunger mechanism or the like may be added to the intermediate gear. By providing the locking mechanism, it is possible to convert the accelerator device into a footrest, for example, during autonomous driving. In the embodiments described above, the speed reducer mechanism includes the three gears, i.e., the motor gear, the intermediate gear, and the output gear, with two speed reduction stages. In another embodiment, the number of speed reduction stages may be three or more. Furthermore, the large gear portion and the small gear portion of the intermediate gear may be separate components which are separately formed.

In the embodiments described above, the drive power source is the brushed DC motor. In another embodiment, an electric motor other than the brushed DC motor may be used as the drive power source. Additionally, the configuration of the drive force transmission mechanism and the arrangement of its components may differ from the embodiments described above. Additionally, the angle detector device may differ from the embodiments described above, such as using a resolver or an encoder.

As described above, the present disclosure is not limited to the embodiments described above and can be implemented in various forms without departing from the spirit of the present disclosure.

The present disclosure has been described with reference to the embodiments. However, the present disclosure is not limited to the above embodiments and the structures described therein. The present disclosure also includes various variations and variations within the equivalent range. Also, various combinations and forms, as well as other combinations and forms that include only one element, more, or less, are within the scope and ideology of the present disclosure.

What is claimed is:

1. An actuator configured to apply a reaction force to a pedal lever that is configured to be depressed by a human driver of a vehicle, the actuator comprising:
an electric motor;
a speed reducer mechanism that includes:
a motor gear that is configured to rotate integrally with the electric motor;
an output gear that is configured to rotate integrally with an output shaft; and
an intermediate gear that is installed between the motor gear and the output gear;
an actuator lever that is configured to be driven by the output shaft and is configured to contact the pedal lever; and
an angle detector device that is configured to detect a rotational angle of the intermediate gear, wherein:
the intermediate gear has:
a large gear portion, which meshes with the motor gear; and
a small gear portion, which meshes with the output gear, wherein the small gear portion is integrally formed in one-piece with the large gear portion;
the intermediate gear is rotatably supported by a bearing member; and
the angle detector device, the large gear portion, the small gear portion and the bearing member are arranged in this order from one side in an axial direction of the intermediate gear.

2. The actuator according to claim 1, wherein:
the intermediate gear is configured to rotate integrally with an intermediate shaft; and
the bearing member is a plurality of ball bearings, and the intermediate shaft is rotatably supported by a housing through the plurality of ball bearings.

3. The actuator according to claim 2, wherein the bearing member is configured to support the intermediate shaft in a state where an internal clearance of the bearing member is zero or less.

4. The actuator according to claim 1, wherein:
the intermediate gear is configured to rotate integrally with an intermediate shaft; and
the bearing member is a needle bearing, and the intermediate shaft is rotatably supported by a housing through the needle bearing.

5. The actuator according to claim 4, wherein the bearing member is configured to support the intermediate shaft in a state where an internal clearance of the bearing member is zero.
